(19) United States
(12) Patent Application Publication
(10) Pub. No.: US 2011/0110287 A1
(43) Pub. Date: May 12, 2011

(54) NAVIGATION TERMINAL, METHOD AND SYSTEM FOR UPDATING MAP VIA FUSION OF BROADCASTING AND TELECOMMUNICATIONS

(75) Inventors: Kyoung-Wook Min, Daejeon (KR); Ju Wan Kim, Daejeon (KR); Kyoung Hwan An, Daejeon (KR); In Sung Jang, Daejeon (KR); Moon Soo Lee, Daejeon (KR)

(73) Assignee: Electronics and Telecommunications Research Institute, Daejeon (KR)

(21) Appl. No.: 13/000,237

(22) PCT Filed: Dec. 12, 2008
(86) PCT No.: PCT/KR08/07378

§ 371 Date: Dec. 20, 2010

(30) Foreign Application Priority Data
Jul. 8, 2008 (KR) 10-2008-0066169

(51) Int. Cl. H04W 4/06; H04W 88/02; H04H 60/00

(52) U.S. Cl. 370/312

(57) ABSTRACT

A method for updating a map in a navigation terminal via fusion of broadcasting and telecommunications includes: receiving map contents of the map from a broadcast center via a broadcast network; classifying the map contents received via the broadcast network into updatable map contents and un-updatable map contents which have dependencies with map contents having not been received by the navigation terminal; and updating the map using the updatable map contents. The method further includes requesting the broadcast center via a wired/wireless telecommunications network to download map contents of the map, which have not been received but have dependencies with the un-updatable map contents; receiving the requested map contents from the broadcast center via the wired/wireless telecommunications network; and updating the map by aggregating the un-updatable map contents with the requested map contents.

### TECHNICAL FIELD

### Cross-Reference(S) To Related Application

The present invention claims priority of Korean Patent Application No. 10-2008-0066169, filed on Jul. 8, 2008, which is incorporated herein by reference.

The present invention relates to a navigation terminal, method and system for updating a map for navigation systems; and, more particularly, to a navigation terminal, method and system for updating a map via the fusion of broadcasting and telecommunications, wherein a navigation terminal having a broadcast receiver, e.g., a DMB (Digital Multimedia Broadcasting) receiver, receives map contents having therein updated information on the map from a broadcast center via a broadcast network, thus performing a fast update while minimizing an update cost.

### BACKGROUND ART

In general, a navigation system detects a current location of a moving object, e.g., an automobile, based on location information received from a GPS (Global Positioning System) and shows on a map the current location and driving information to a destination of the moving object. In order to provide optimal driving information, the navigation system needs to perform a fast update on the map with the latest map data.

In conventional map update methods, the navigation system is connected to a map server provided by the navigation system manufacturer via a wired telecommunications network to update the entire map, or connected to the map server via a wireless telecommunications network to receive and partially update changed parts of the map.

However, the former method has a drawback in that a waste of time arises because the entire map is updated even when the map is partially, not fully, changed. Meanwhile, the latter method has a drawback in that an excessively high communications expense is charged to a user.

### DISCLOSURE OF INVENTION

### Technical Problem

In view of the above, the present invention provides a navigation terminal, method and system for updating a map via the fusion of broadcasting and telecommunications, wherein a navigation terminal having a broadcast receiver, e.g., a DMB receiver, receives map contents having therein updated information on the map from a broadcast center via a broadcast network, thus performing a fast update while minimizing an update cost.

### Technical Solution

In accordance with an aspect of the invention, there is provided a method for updating a map in a navigation terminal via fusion of broadcasting and telecommunications, the method including: receiving map contents of the map from a broadcast center via a broadcast network; classifying the map contents received via the broadcast network into updatable map contents and un-updatable map contents which have dependencies with map contents having not been received by the navigation terminal; updating the map using the updatable map contents; requesting the broadcast center via a wired/wireless telecommunications network to download map contents of the map, which have not been received but have dependencies with the un-updatable map contents; receiving the requested map contents from the broadcast center via the wired/wireless telecommunications network; and updating the map by aggregating the un-updatable map contents with the requested map contents.

In accordance with another aspect of the invention, there is provided a navigation terminal for updating a map via fusion of broadcasting and telecommunications, the navigation terminal including: a broadcast receiver for receiving map contents of the map via a broadcast network; a controller for classifying the map contents received via the broadcast network into updatable map contents and un-updatable map contents which have dependencies with map contents having not been received by the broadcast receiver, and updating the map using the updatable map contents; a storage for storing therein the un-updatable map contents; and a wired/wireless communications unit for, under the control of the controller and via a wired/wireless telecommunications network, requesting to download map contents, which have not been received via the broadcast-receiving unit but have dependencies with the un-updatable map contents, and receiving the requested map contents, wherein the controller updates the map using the un-updatable map contents by aggregating therewith the requested map contents.

In accordance with still another aspect of the invention, there is provided a system for updating a map via fusion of broadcasting and telecommunications, the system including; a broadcast center for broadcasting map contents of the map via a broadcast network; and a navigation terminal for receiving the map contents broadcasted from a broadcast center via the broadcast network to update the map using the received map contents, wherein the navigation terminal requests the broadcast center to download map contents of the map, which have not been received by the navigation terminal but have dependencies with the map contents received via the broadcast network, via a wired/wireless telecommunications network.

### Advantageous Effects

According to the present invention, a navigation terminal classifies map contents received from a broadcast center via a broadcast network into updatable and un-updatable map contents to update the updatable map contents. The un-updatable map contents are temporarily stored in the navigation terminal and updated after map contents having dependencies with the un-updatable map contents are downloaded by the broadcast center via a wired/wireless telecommunications network. Hence, the map can be updated fast with a relatively low cost.

### BRIEF DESCRIPTION OF THE DRAWINGS

The above features of the present invention will become apparent from the following description of an embodiment, given in conjunction with the accompanying drawings, in which:

FIG. 1 illustrates map contents broadcasting via a broadcast network in accordance with an embodiment of the present invention;

FIG. 2 illustrates map contents which are broadcasted via the broadcast network and classified into updatable and un-updatable map contents in the navigation terminal of FIG. 1;

FIG. 3 illustrates a map contents update system in accordance with the embodiment of the present invention;

FIG. 4 illustrates a flowchart of a map contents update procedure in the navigation terminal of FIG. 3;

FIG. 5 illustrates an example of dependencies between map contents;

FIG. 6 illustrates map data update procedures in two navigation terminals in accordance with the embodiment of the present invention, wherein the map contents have the dependencies of FIG. 5 and the navigation terminals are powered on at different time;

FIG. 7 illustrates another example of dependencies between map contents; and

FIG. 8 illustrates map data update procedures in five navigation terminals in accordance with the embodiment of the present invention, wherein the map contents have the dependencies of FIG. 7 and the navigation terminals are in a power-on state at different time periods.

### BEST MODE FOR CARRYING OUT THE INVENTION

Hereinafter, an embodiment of the present invention will be described in detail with reference to the accompanying drawings, which form a part hereof.

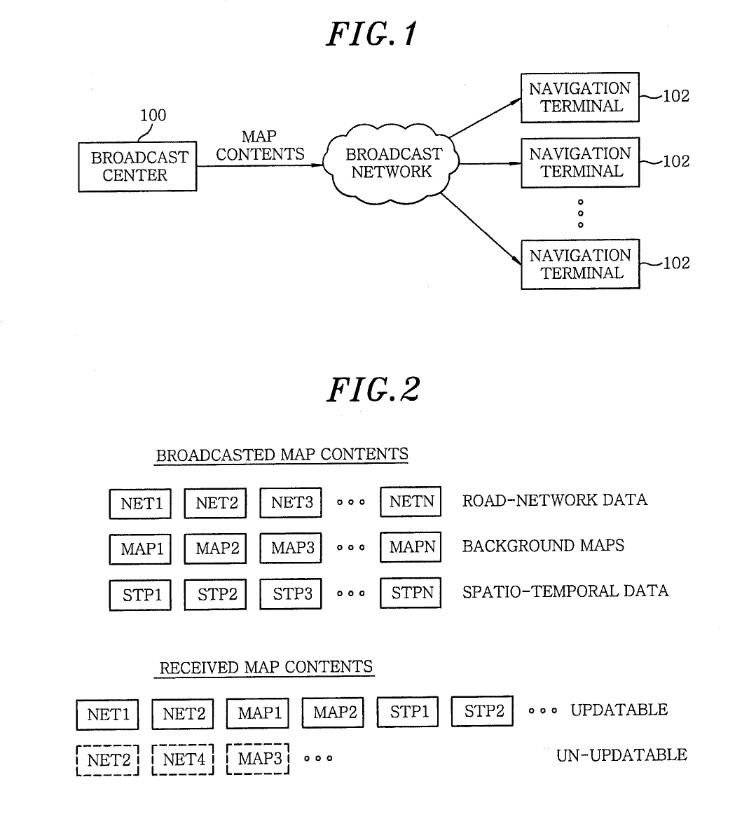

FIG. 1 illustrates map contents broadcasting via a broadcast network in accordance with an embodiment of the present invention.

As shown in FIG. 1, a broadcast center 100 broadcasts map contents via a broadcast network. The map contents may include maps, road networks, POIs (Points of Interest), real-time traffic/accident information, dynamic spatio-temporal data having life times and the like. Then, navigation terminals 102 in the broadcast network receive the map contents to update a map. Here, each navigation terminals 102 may be an apparatus, e.g., a car navigation terminal, mounted on a moving object to show on a map a current location and movement information of the moving object. Further, the term “update” includes “addition”, “deletion” and “modification”.

FIG. 2 illustrates map contents which are broadcasted via the broadcast network and classified into updatable and un-updatable map contents in the navigation terminal 102 of FIG. 1.

As shown in FIG. 2, map contents broadcasted via the broadcast network are limited to map data (e.g., background maps, road-network data and the like) and spatio-temporal data having life times in this disclosure, however, they can be any other map contents obvious to those skilled in the art without departing from the scope of the present invention.

Among the map contents broadcasted via the broadcast network, the spatio-temporal data are map contents having specific temporal information, i.e., life times, as well as spatial information. For example, in case of oiling price cut information, a price cut period (temporal information) and location (spatial information) of a gas station are stored in the navigation terminal 102 to provide the price cut information to drivers moving toward the gas station only until life time thereof expires. That is, the spatio-temporal data are stored in the navigation terminal 102 until their respective life times expire, without being affected by other map contents.

However, the map data, i.e., the background maps and the road-network data, are stored permanently in the navigation terminal 102 while partially or entirely updated using other map data to be broadcasted later. From this, the background maps and the road-network data are classified into updatable and un-updatable map contents, as shown in FIG. 2. Here, a criterion of the classification is “dependencies” which will be described below.

For example, if a name of an object is changed but the object does not exist on a background map, the name cannot be modified on the background map. Such situation occurs more frequently on the road-network data, which results in serious problems in updating a map via the broadcast network.

To be specific, suppose that a newly-constructed building is added to a background map at time T1 and then a name of the building is changed at time T2. If a navigation terminal 102 is in the power-on state at both of the times T1 and T2, the navigation terminal 102 can modify the name. However, if the navigation terminal 102 is in the power-on state at the time T2 but in the power-off state at the time T1, the navigation terminal 102 cannot modify the name of the building because the navigation terminal 102 only received map contents (modification data) broadcasted at the time T2 without receiving map contents (addition data) broadcasted at the time T1, i.e., because the navigation terminal 102 has a background map on which the building does not exist.

The above-described relationships between map contents are referred to as “dependencies”. In FIG. 2, the map contents NET2, NET4 and MAP3 are classified into un-updatable map contents due to their dependencies with previously broadcasted map contents (not shown).

In order to update a map using map contents having dependencies with previously broadcasted map contents, the navigation terminal 102 is required to have the previously broadcasted map contents. However, in the broadcast network, navigation terminals in a power-off state cannot receive the map contents broadcasted by the broadcast center while other navigation terminals in a power-on state receive the map contents. Further, since broadcasting is a simplex data communications scheme in which a single server transmits data to a plurality of terminals, the terminals cannot request the broadcast center to transmit the map contents broadcasted while the terminals were in the power-off state.

Accordingly, in the present invention, the navigation terminal 102 temporarily stores in a memory the un-updatable map contents, which are map contents cannot be used in updating a map because the navigation terminal 102 does not have map contents with which the un-updatable map contents have dependencies, and updates the map using the un-updatable map contents after receiving the map contents with which the un-updatable map contents have dependencies via a wired/wireless telecommunications network other than the broadcast network.

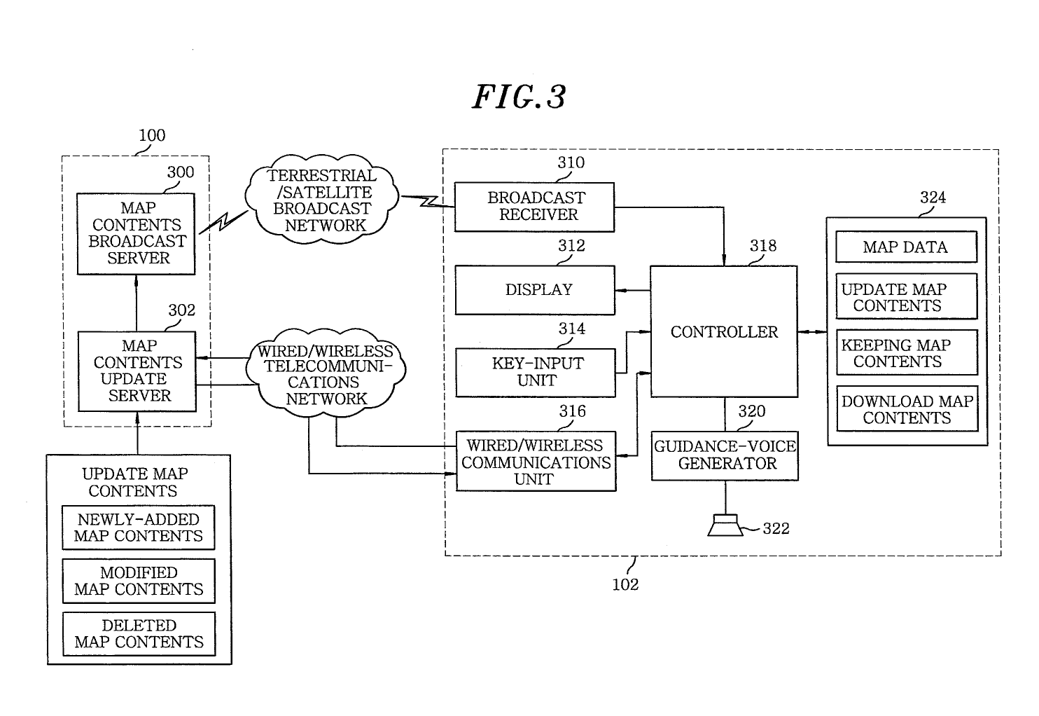

FIG. 3 illustrates a map update system in accordance with the embodiment of the present invention. Below, operation of each unit of the broadcast center 100 and the navigation terminal 102 to update a map using map contents via the fusion of broadcasting and telecommunications will be described in detail with reference to FIG. 3.

As shown in FIG. 3, the broadcast center 100 includes a map contents broadcast server 300 and a map contents update server 302.

The map contents update server 302 is provided, from map production companies or contents providers, map contents including map contents to be newly-added to a map, modified on the map and deleted from the map. The map contents update server 302 provides the map contents to the map contents broadcast server 300. Further, when the navigation terminal 102 requests specific map contents, the map contents update server 302 searches to download the specific map contents to the navigation terminal 102 via a wired/wireless telecommunications network. The wireless telecommunications network for downloading the map contents may include a CDMA (Code Division Multiple Access), W-CDMA (Wideband-CDMA), WiBro (Wireless Broadband), HSDPA (High Speed Downlink Packet Access), WiMax (Worldwide Interoperability for Microwave Access) network and the like. Further, the wired telecommunications network for downloading the map contents may be any landline broadband network.

The map contents broadcast server 300 transmits the map contents received from the map contents update server 302 to the navigation terminal 102 for an appropriate period of time based on a broadcast scheduling via the broadcast network, e.g., a terrestrial or satellite DMB network and the like.

As shown in FIG. 3, the navigation terminal 102 includes a broadcast receiver 310, a display 312, a key-input unit 314, a wired/wireless communications unit 316, a controller 318, a guidance-voice generator 320, a speaker 322 and a memory 324.

The broadcast receiver 310, e.g., a DMB receiver, receives the map contents broadcasted from the map contents broadcast server 300 of the broadcast center 100 via the broadcast network, and provides the map contents to the controller 318. The display 312 displays operational status information of the navigation terminal 102 and road information, e.g., map data according to a driving of an automobile. The key-input unit 314 has a key panel for receiving key-inputs from a user, and, based on the key-inputs, generates key-data for controlling operations of the navigation terminal 102. The key-data is provided to the controller 318. The guidance-voice generator 320 generates, under the control of the controller 318, a guidance-voice according to a driving status, and outputs the guidance-voice via the speaker 322.

The wired/wireless communications unit 316 accesses, under the control of the controller 318, the map contents update server 320 of the broadcast center 100 via the wired/wireless telecommunications network to request a download of map contents which have not been received by the navigation terminal 102. The wired/wireless communications unit 316 then receives the requested map contents, which are downloaded via the wired/wireless telecommunications network by the map contents update server 302 in response to the download request of the wired/wireless communications unit 316. For a wireless connection with the map contents update server 302, the wired/wireless communications unit 316 has at least one wireless communications module, e.g., a CDMA, W-CDMA, WiBro, HSPDA, WiMax module and the like.

The controller 318 detects a current location of a moving object, e.g., an automobile, by using the map data stored in the memory 324, and, based thereon, controls overall operation of the navigation terminal 102 to show on a map the current location and driving information to a destination of the moving object.

The memory 324 may include a volatile memory, e.g., a RAM (Random Access Memory), or a non-volatile memory, e.g., a flash memory, a hard disk and the like. Further, the memory 324 is divided into a map data region, an update map contents region, a keeping map contents region and a download map contents region, according to map contents stored therein.

When map contents broadcasted from the broadcast center 100 are received via the broadcast receiver 310, the controller 318 temporarily stores the received map contents in the update map contents region in the memory 324 to update the map using the received map contents. If the temporarily map contents are un-updatable map contents, the controller 318 stores the received map contents in the keeping map contents region in the memory 324. Thereafter, in response to a user's request via the key-input unit 314, the controller 318 establishes a connection between the navigation terminal 102 and the map contents update server 320 of the broadcast center 100 via the wired/wireless communications unit 316 to request a download of map contents which have not been received by the navigation terminal 102 but have dependencies with the un-updatable map contents. After the requested map contents are downloaded, the controller 318 stores the downloaded map contents in the download map contents region in the memory 324 and aggregates the downloaded map contents with the un-updatable map contents stored in the keeping map contents region to thereby update the map.

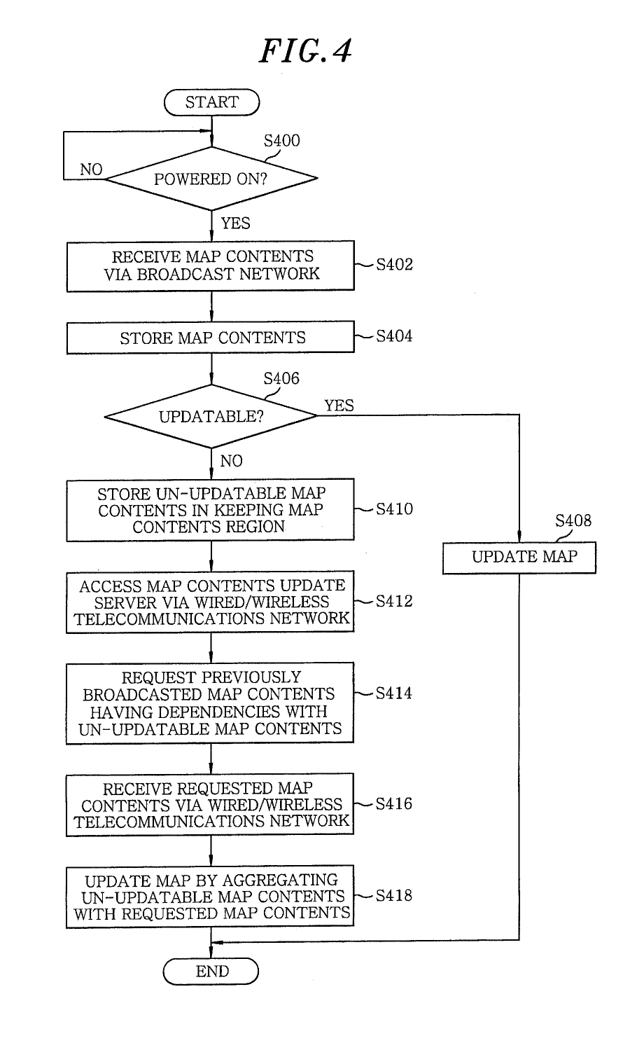

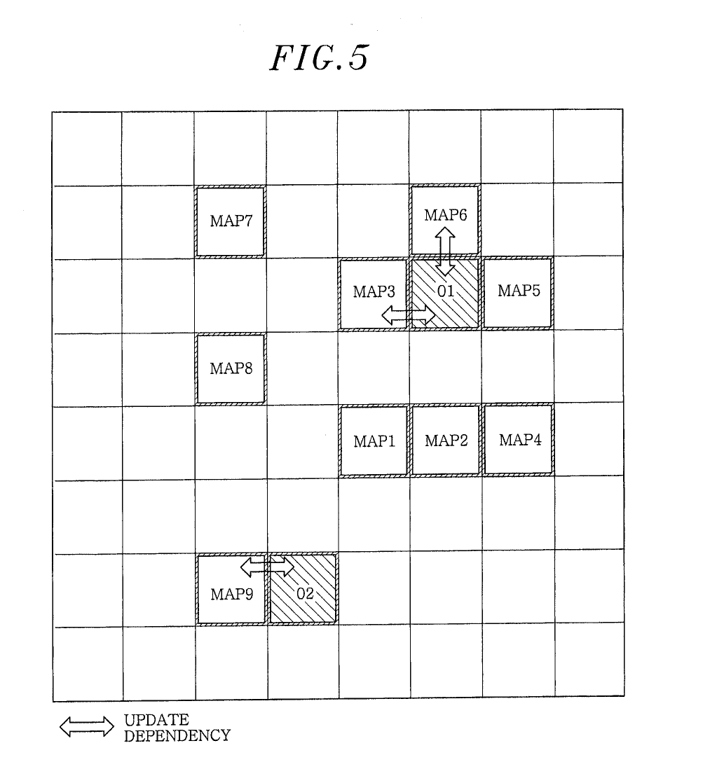

FIG. 4 illustrates a flowchart of a map contents update procedure in the navigation terminal of FIG. 3. Below, the embodiment of the present invention will be described in detail with reference to FIGS. 3 and 4.

First, the navigation terminal 102 capable of receiving broadcasted data and also performing wired or wireless communications is powered on (step S400). After the navigation terminal 102 is powered on in the step S400, the broadcast receiver 310 receives, under the control of the controller 318, map contents broadcasted from the map contents broadcast server 300 of the broadcast center 100 via the broadcast network (step S402).

The controller 318 stores the received map contents in the update map contents region in the memory 324 (step S404). After that, the controller 318 determines whether thus stored map contents are updatable map contents or not (step S406).

As described above, the map contents broadcasted by the map contents broadcast server 300 may include map contents having therein partially updated information on the map, i.e., map contents having dependencies with previously broadcasted map contents. Among such map contents, map contents, which have one or more previously broadcasted map contents having not been received by the navigation terminal 102 because the navigation terminal 102 was in the power-off state when the previously broadcasted map contents were broadcasted, cannot be updated due to the dependencies therebetween.

If the map contents stored in the step S404 do not have dependencies with previously broadcasted map contents or the previously broadcasted map contents having dependencies with the stored map contents have been received and used in updating the map, the controller 318 updates the map using the stored map contents (step S408).

However, if the map contents stored in the step S404 have dependencies with previously broadcasted map contents and the navigation terminal 102 has not received the previously broadcasted map contents, the controller 318 determines the stored map contents as un-updatable map contents in the step S406 and stores the un-updatable map contents in the keeping map contents region in the memory 324 (step S410).

In order to update the map using the un-updatable map contents stored in the keeping map contents region, the controller 318 establishes a connection between the navigation terminal 102 and the map contents update server 320 of the broadcast center 100 via the wired/wireless communications unit 316 (step S412), and then requests a download of the map contents having dependencies with the un-updatable map contents (step S414). In response to the download request, the map contents update server 320 searches to download the map contents requested by the navigation terminal 102 in the step S414 via the wired/wireless telecommunications network.

The controller 318 then receives the map contents downloaded by the map contents update server 302 (step S416). Thereafter, the controller 318 aggregates the downloaded map contents with the un-updatable map contents stored in the keeping map contents region in the memory 324 to thereby update the map (step S418).

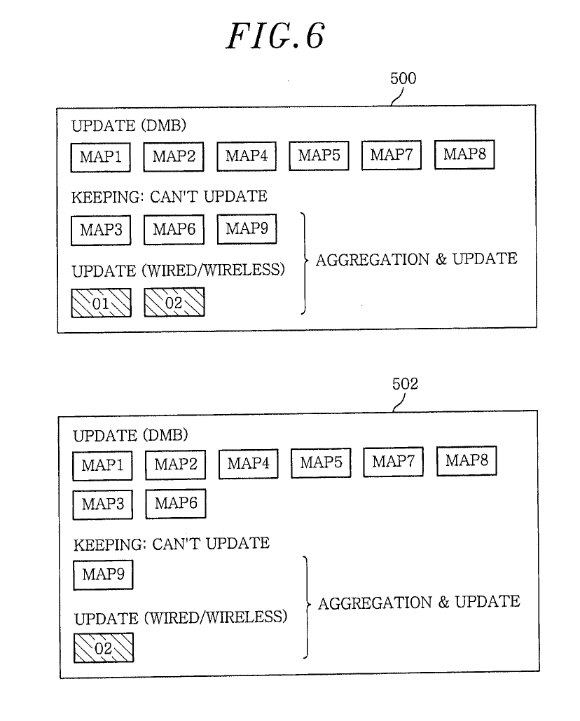

Below, an example of map data update procedures will be described with reference to FIGS. 5 and 6.

As shown in FIG. 6, navigation terminals 500 and 501 receive broadcasted map contents MAP1 to MAP9 having dependencies therebetween as in FIG. 5. As for the terminal 500, map updates using previously broadcasted map contents 01 and 02 cannot be performed because the navigation terminal 500 has not received the map contents 01 and 02. In this case, the navigation terminal 500 requests a download of the map contents 01 and 02 via a wired/wireless telecommunications network. After receiving the downloaded map contents 01 and 02, the navigation terminal 500 aggregates the map contents 01 with the map contents MAP3 and MAP6 and also aggregates the map contents 02 with the map contents MAP9, to thereby update the map.

Meanwhile, the navigation terminal 502 has received the previously broadcasted map contents 01 and already updated the map using the map contents 01, Since the navigation terminal 502 has not updated the map using the map contents 02, a map update using the map contents MAP9 cannot be performed. Accordingly, the terminal 02 requests a download of the map contents 02 via the wired/wireless telecommunications network, and after receiving the map contents 02, updates the map by aggregating the downloaded map contents 02 and the map contents MAP9.

For purposes of understanding, each of the map contents MAP1 to MAP9 includes information on a cell in the map, i.e., a mesh or partition, in FIG. 5. However, map contents having dependencies therebetween actually may be information on objects in the cell.

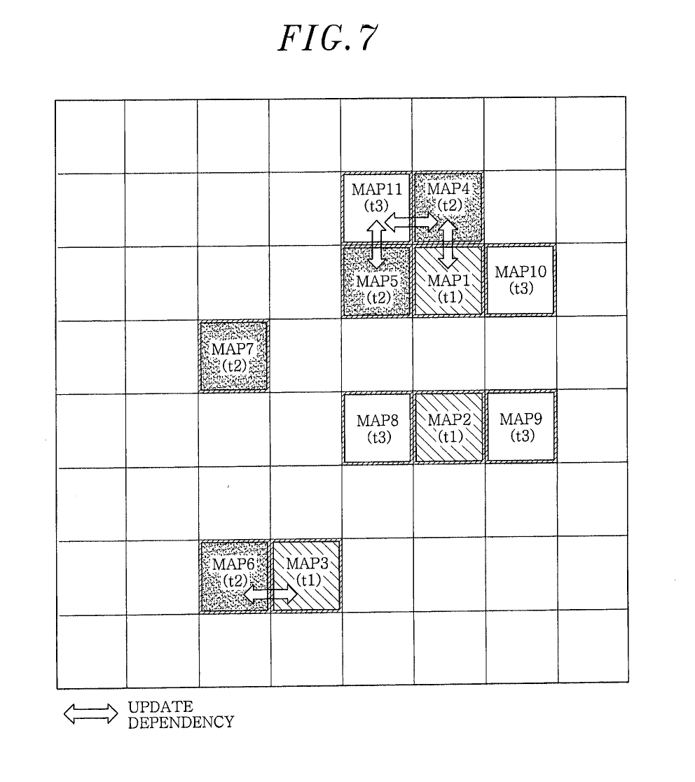

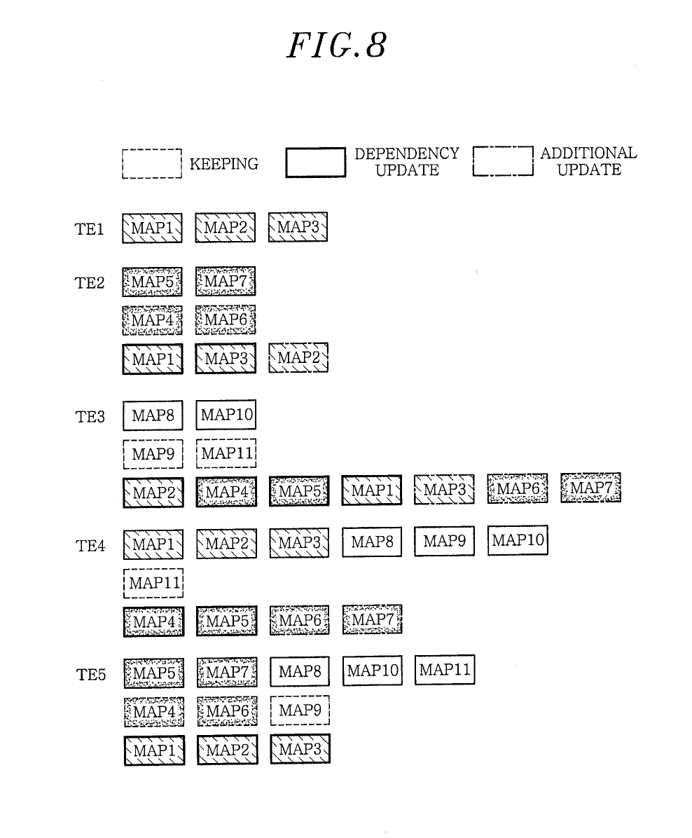

Below, a more complicated example of map data update procedures will be described with reference to FIGS. 7 and 8.

In FIG. 7, map contents MAP1 to MAP3, MAP4 to MAP7 and MAP8 to MAP11 are broadcasted during time periods t1, t2 and t3, respectively, Also, dependencies between the map contents MAP1 to MAP11 are indicated by arrows in FIG. 7. FIG. 8 illustrates map data update procedures in five navigation terminals TE1 to TE5, wherein the map contents MAP1 to MAP11 have the dependencies of FIG. 7 and the navigation terminals TE1 to TE5 are in the power-on state at different time periods.

The navigation terminal TE1 is powered on during the time period t1 and powered off during the time periods t2 and t3. Accordingly, the navigation terminal TE1 updates the map using the map contents MAP1 to MAP3 only.

The navigation terminal TE2 is powered on only during the time period t2, and thus the navigation terminal TE2 updates the map using the map contents MAP8 and MAP10 and stores un-updatable map contents MAP4 and MAP6 in the keeping map contents region in a memory. After that, the navigation terminal TE2 requests the map contents update server 302 to download the map contents MAP1 and MAP3 via the wired/wireless telecommunications network to update the map using the map contents MAP4 and MAP6 (hereinafter, such type of update will be referred to as “dependency update”). At this time, the navigation terminal TE2 may also request the map contents update server 302 to download the map contents MAP2 to update the map using the map contents MAP2 (hereinafter, such type of update will be referred to as “additional update”).

The navigation terminal TE3 is powered on during the time period t3 and powered off during the time periods t1 and t2. Thus, the navigation terminal TE3 updates the map using the map contents MAP8 and MAP10 while storing the map contents MAP9 and MAP11 in the keeping map contents region. Thereafter, the navigation terminal TE3 performs dependency updates using the map contents MAP1, MAP2, MAP4 and MAPS and additional updates using the map contents MAP3, MAP6 and MAP7.

The navigation terminal TE4 is powered on during the time periods t1 and t3 and powered off during the time period t2, Thus, the navigation terminal TE4 updates the map using the map contents MAP1 to MAP3 during the time period t1. Further, the navigation terminal TE4 updates the map contents MAP8 to MAP10 while storing the map contents MAP11 in the keeping map contents region during the time period t3. Thereafter, the navigation terminal TE4 performs dependency updates using the map contents MAP4 and MAPS and additional updates using the map contents MAP6 and MAP7.

The navigation terminal TE5 is powered on during the time periods t2 and t3 and powered off during the time period t1. Thus, the navigation terminal TE5 update the map using the map contents MAPS and MAP7 while storing the map contents MAP4 and MAP6 in the keeping map contents region during the time period t2. Further, the navigation terminal TE5 updates the map using the map contents MAP8, MAP10 and MAP 11 while storing the map contents MAP9 in the keeping map contents region during the time period t3. After that, the navigation terminal TE5 receives the map contents MAP1 to MAP3 via the wired/wireless telecommunications network to thereby perform dependency updates.

While the invention has been shown and described with respect to the embodiment, it will be understood by those skilled in the art that various changes and modification may be made without departing from the scope of the invention as defined in the following claims.

1. A method for updating a map in a navigation terminal via fusion of broadcasting and telecommunications, the method comprising:
receiving map contents of the map from a broadcast center via a broadcast network;
classifying the map contents received via the broadcast network into updatable map contents and un-updatable map contents which have dependencies with map contents having not been received by the navigation terminal;
updating the map using the updatable map contents;
requesting the broadcast center via a wired/wireless telecommunications network to download map contents of the map, which have not been received but have dependencies with the un-updatable map contents;
receiving the requested map contents from the broadcast center via the wired/wireless telecommunications network; and
updating the map by aggregating the un-updatable map contents with the requested map contents.

2. The method of claim 1, wherein the map is divided into same-sized cells having therein modified objects and the map contents are broadcasted on a cell basis or on an object basis.

3. The method of claim 1, wherein the broadcast network includes a terrestrial digital multimedia broadcasting network and a satellite digital multimedia broadcasting network.

4. The method of claim 1, wherein the wired/wireless telecommunications network includes one of a CDMA (Code Division Multiple Access), W-CDMA (Wideband-CDMA), WiBro (Wireless Broadband), HSDPA (High Speed Downlink Packet Access), WiMax (Worldwide Interoperability for Microwave Access) and landline broadband network.

5. The method of claim 2, wherein the map contents includes map data, real-time traffic information and additional data having life times.

6. A navigation terminal for updating a map via fusion of broadcasting and telecommunications, the navigation terminal comprising:
a broadcast receiver for receiving map contents of the map via a broadcast network;
a controller for classifying the map contents received via the broadcast network into updatable map contents and un-updatable map contents which have dependencies with map contents having not been received by the broadcast receiver, and updating the map using the updatable map contents;
a storage for storing therein the un-updatable map contents; and
a wired/wireless communications unit for, under the control of the controller and via a wired/wireless telecommunications network, requesting to download map contents, which have not been received via the broadcast-receiving unit but have dependencies with the un-updatable map contents, and receiving the requested map contents,
wherein the controller updates the map using the un-updatable map contents by aggregating therewith the requested map contents.

7. The navigation terminal of claim 6, wherein the map is divided into same-sized cells having therein modified objects and the map contents are broadcasted on a cell basis or on an object basis.

8. The navigation terminal of claim 6, wherein the broadcast receiver includes a terrestrial digital multimedia broadcasting receiver or a satellite digital multimedia broadcasting receiver.

9. The navigation terminal of claim 6, wherein the wired/wireless telecommunications network includes one of a landline broadband, CDMA (Code Division Multiple Access), W-CDMA (Wideband-CDMA), WiBro (Wireless Broadband), HSDPA (High Speed Downlink Packet Access), WiMax (Worldwide Interoperability for Microwave Access) and landline broadband network.

10. The navigation terminal of claim 7, wherein the map contents includes map data, real-time traffic information and additional data having life times.

11. A system for updating a map via fusion of broadcasting and telecommunications, the system comprising:
a broadcast center for broadcasting map contents of the map via a broadcast network; and
a navigation terminal for receiving the map contents broadcasted from a broadcast center via the broadcast network to update the Map using the received map contents,
wherein the navigation terminal requests the broadcast center to download map contents of the map, which have not been received by the navigation terminal but have dependencies with the map contents received via the broadcast network, via a wired/wireless telecommunications network.

12. The system of claim 11, wherein the broadcast center includes:
a map contents broadcast server for broadcasting the map contents via the broadcast network; and
a map contents update server for providing the map contents to the map contents broadcast server and also downloading, in response to the download request from the navigation terminal, the requested map contents to the navigation terminal via the wired/wireless telecommunications network.

13. The system of claim 11, wherein the navigation terminal includes:
a broadcast receiver for receiving the map contents broadcasted from a broadcast center via a broadcast network;
a controller for classifying the map contents received via the broadcast network into updatable map contents and un-updatable map contents which have dependencies with map contents having not been received by the navigation terminal, updating the map using the updatable map contents and storing the un-updatable map contents;
a storage for storing therein the un-updatable map contents; and
a wired/wireless communications unit for, under the control of the controller and via a wired/wireless telecommunications network, accessing the broadcast center to request the broadcast center to download map contents, which have not been received via the broadcast-receiving unit but have dependencies with the un-updatable map contents, and receiving the requested map contents from the broadcast center,
wherein the controller updates the map using the un-updatable map contents by aggregating therewith the requested map contents.
